(19) United States
(12) Patent Application Publication
(10) Pub. No.: US 2010/0274569 A1
(43) Pub. Date: Oct. 28, 2010

(54) REAL-TIME LOCATION SHARING

(76) Inventor: DOUGLAS REUDINK, Port Townsend, WA (US)

Correspondence Address: JENSEN & PUNTIGAM, P.S., 2033 SIXTH AVENUE, SUITE 1020, SEATTLE, WA, 98121-2527, US

(21) Appl. No.: 12/429,171

(22) Filed: Apr. 23, 2009

(51) Int. Cl. G06Q 10/00

(52) U.S. Cl. 705/1.1

(57) ABSTRACT

The present disclosure generally describes that real-time location information may be exchanged among devices and a communications system, allowing for users to locate other users in real-time for determining whether such users may advantageously engage in collective activities. An example communications system may acquire and store device location information corresponding to devices in a user information database. The user information database may also include a variety of additional information such as user preferences, destinations, and place of work. Device location information and such additional information may be provided to devices by the communications system upon request.

### BACKGROUND

So-called cell phone location technologies and lightweight, inexpensive Global Positioning System (GPS) units allow for a wide variety of new and exciting location-based services, such as location-based advertising and driving directions. These first-generation location-based services generally rely on aggregating static location-based information on a network server, determining a customer location, and then providing the customer with any such static location-based information associated with the customer location.

First-generation location-based services have been slow to incorporate dynamic location-based information, however. For example, location-based services have yet to be valuably deployed for bus and ride sharing. As a result of escalating gasoline prices and traffic congestion, services such as ride sharing have become increasingly popular. However, these services do not offer real-time, location-specific information. For example, if a user wants to share a ride from street A to street B at a particular moment, there is not an existing means for the user to find out in real time which other users would be available and willing to share the ride. In addition, privacy and security concerns may inhibit users from sharing their current location and other personal information with other users if they believe they would not have control over the ways in which their personal information might be used.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are therefore not to be considered limiting of its scope, the disclosure will be described with additional specificity and detail through use of the accompanying drawings, in which:

FIG. 1 is a block diagram illustrating one example of a communications system 100 configured to facilitate real-time location information sharing among devices;

FIG. 2 is a block diagram illustrating a computing device 200 as one example of a network server that may serve as a network server 101 from FIG. 1;

FIG. 3A is a block diagram illustrating an example communications system 300 as may implement aspects of communications system 100 in FIG. 1;

FIG. 3B is a block diagram illustrating an example communications system 300 as may implement aspects of communications system 100 in FIG. 1;

FIG. 3C is a block diagram illustrating an example communications system 300 as may implement aspects of communications system 100 in FIG. 1;

FIG. 3D is a block diagram illustrating another example communications system 300 as may implement aspects of communications system 100 in FIG. 1;

FIG. 4 is a block diagram illustrating an example communications device as may implement a communications device 161 in FIG. 1;

FIG. 5A is a block diagram illustrating an example method that may be performed in connection with a communications device as illustrated in FIG. 4;

FIG. 5B is a block diagram illustrating an example method that may be performed in connection with a communications device as illustrated in FIG. 4;

FIG. 5C is a block diagram illustrating an example method that may be performed in connection with a communications device as illustrated in FIG. 4;

FIG. 5D is a block diagram illustrating an example method that may be performed in connection with a communications device as illustrated in FIG. 4; and

FIG. 5E is a block diagram illustrating an example method that may be performed in connection with a communications device as illustrated in FIG. 4, all arranged in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure generally describes systems, methods and devices for allowing users to share real-time information about the users' locations and other information such as destination, place of employment, and so forth, to enable users to identify other users who want to share a ride or engage in other location-based activities.

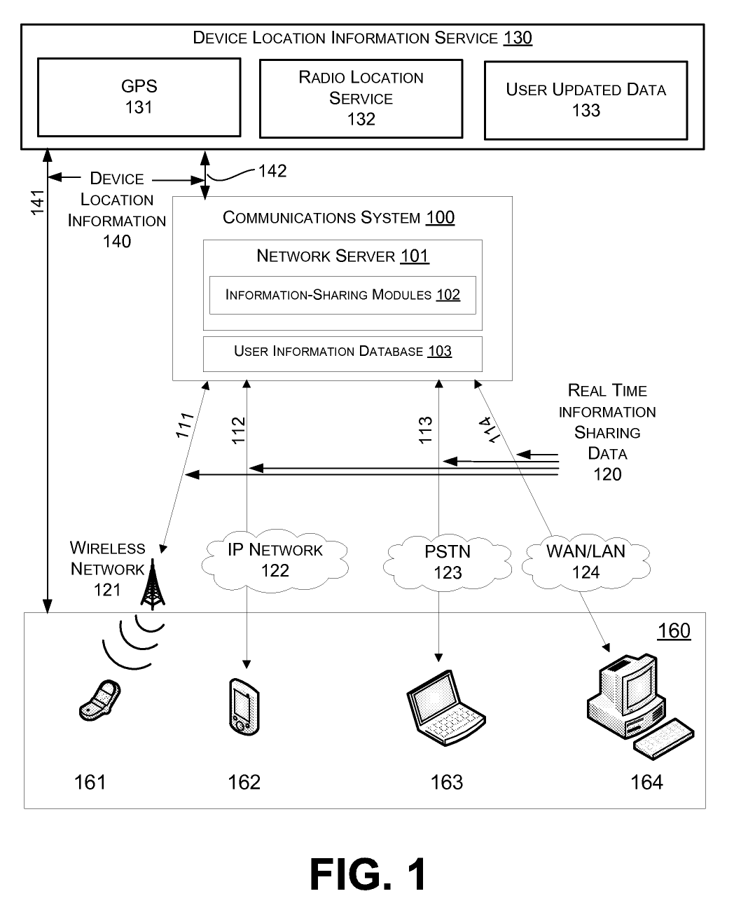

FIG. 1 is a block diagram illustrating one example of a communications system 100 configured to facilitate real-time location information sharing among devices in accordance with the present disclosure. Communications system 100 may include a user information database 103 and one or more network servers 101. Network servers 101 may in turn include information sharing modules 102.

Communications system 100 may be coupled via network connections 111, 112, 113, and 114 to one or more communications devices 160, which may include for example cellular telephones 161, Personal Digital Assistants (PDAs) 162, laptop computers 163, and desktop computers 164. Network connections 111-114 may utilize for example one or more of a wireless network 121, Internet Protocol (IP) network 122, Public Switched Telephone Network (PSTN) 123, and Wide Area Network (WAN)/Local Area Network (LAN) 124.

In some embodiments, communications system 100 may also be coupled via a network connection 142 to a device location information service 130. The device location information service 130 may acquire and maintain real-time device location information for devices 160 using for example one or more of the Global Positioning System (GPS) 131, radio location service 132 technologies, and user updated data 133. The device location information service 130 may establish a communication link 141 with devices 160 as necessary to acquire device location information 140, and may provide device location information 140 to the communications system 100.

Real-time information sharing data 120 may be exchanged among devices 160 and communications system 100. For example, communications system 100 may acquire and store device location information corresponding to devices 160 in the user information database 103. User information database 103 may also include a variety of additional information, discussed in further detail below. Device location information and such additional information may be provided to devices 160 by the communications system 100 upon request, as described in greater detail below.

In FIG. 1, device location information may be obtained by the communications system 100 directly from the devices 160, or may be obtained from a device location information service 130. Devices 160 may be equipped to determine their physical location, and to provide this information to the communications system 100 or to the service 130. Devices 160 may determine their location for example by including a device locator such as a GPS unit, radio location unit, or a user interface that allows a user to input location information. Location information obtained by such a device locator may be sent to the communications system 100 or to the service 130. When location information is obtained from the location information service 130, location information is gathered from devices 160 by the service 130, and the service 130 then supplies the device location information to the communications system 100.

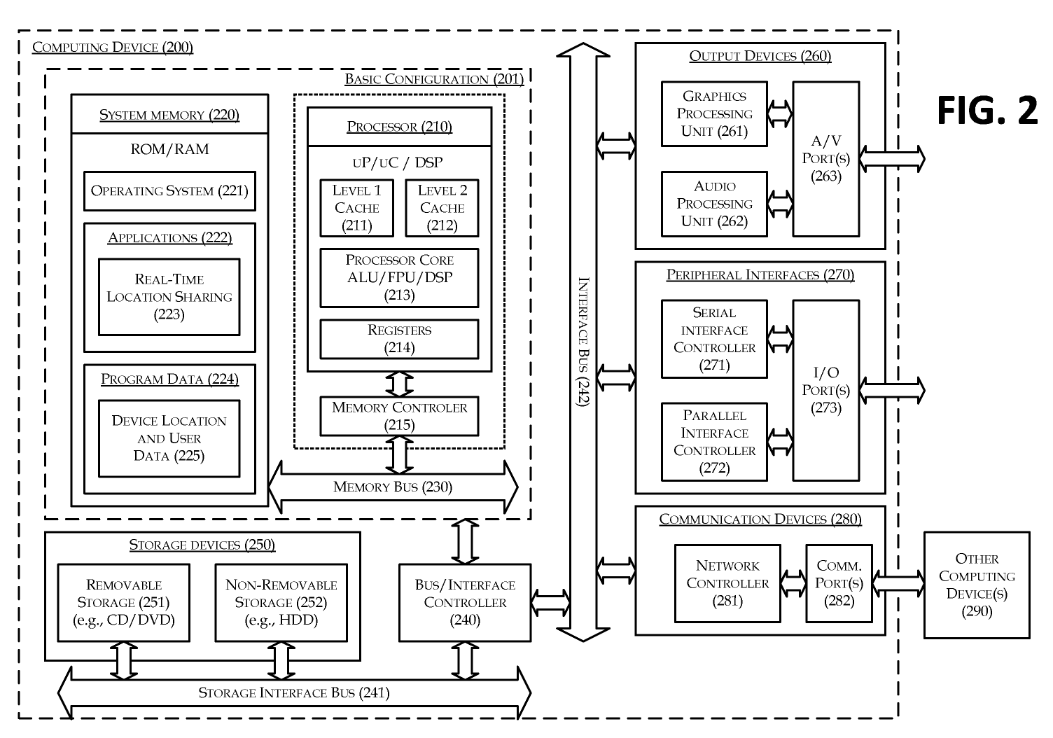

FIG. 2 illustrates a computing device 200 as one example of a network server, for example network server 101 from FIG. 1, arranged in accordance with the present disclosure. In a very basic configuration 201, computing device 200 typically includes one or more processors 210 and system memory 220. A memory bus 230 may be used for communicating between the processor 210 and the system memory 220.

Depending on the desired configuration, processor 210 may be of any type including but not limited to a microprocessor (μP), a microcontroller (μC), a digital signal processor (DSP), or any combination thereof. Processor 210 may include one or more levels of caching, such as a level one cache 211 and a level two cache 212, a processor core 213, and registers 214. The processor core 213 may include an arithmetic logic unit (ALU), a floating point unit (FPU), a digital signal processing core (DSP Core), or any combination thereof. A memory controller 215 may also be used with the processor 210, or in some implementations the memory controller 215 may be an internal part of the processor 210.

Depending on the desired configuration, the system memory 220 may be of any type including but not limited to volatile memory (such as RAM), non-volatile memory (such as ROM, flash memory, etc.), or any combination thereof. System memory 220 typically includes an operating system 221, one or more applications 222, and program data 224. Application 223 may include, for example, the real-time information sharing modules set forth herein. Program data 224 may include, for example, device location and other user data 225 that is used by application 223, as will be further described below. Program data 225 may also be stored in a database such as user information database 103 illustrated in FIG. 1. In such an implementation, the database may be implemented as a module operating in the system memory 220 or on a separate device, as will be appreciated.

Computing device 200 may have additional features or functionality, and additional interfaces to facilitate communications between the basic configuration 201 and any required devices and interfaces. For example, a bus/interface controller 240 may be used to facilitate communications between the basic configuration 201 and one or more data storage devices 250 via a storage interface bus 241. The data storage devices 250 may be removable storage devices 251, non-removable storage devices 252, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

System memory 220, removable storage 251, and non-removable storage 252 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that may be used to store the desired information and that may be accessed by computing device 200. Any such computer storage media may be part of device 200.

Computing device 200 may also include an interface bus 242 for facilitating communication from various interface devices (e.g., output interfaces, peripheral interfaces, and communication interfaces) to the basic configuration 201 via the bus/interface controller 240. Example output devices 260 include a graphics processing unit 261 and an audio processing unit 262, which may be configured to communicate to various external devices such as a display or speakers via one or more A/V ports 263. Example peripheral interfaces 270 include a serial interface controller 271 or a parallel interface controller 272, which may be configured to communicate with external devices such as input devices (e.g., keyboard, mouse, pen, voice input device, touch input device, etc.) or other peripheral devices (e.g., printer, scanner, etc.) via one or more I/O ports 273. An example communications device 280 includes a network controller 281, which may be arranged to facilitate communications with one or more other computing devices 290 over a network communication via one or more communication ports 282. For example, in an embodiment where a device such as computing device 200 serves as a network server 101 as illustrated in FIG. 1, the network server may communicate via communication devices 280 to the various communications devices 161-164 analogous to “other computing devices” 290 in FIG. 2.

The communications connection is one example of a communication media. Communication media may typically be embodied by computer readable instructions, data structures, program modules, or other data in a modulated data signal, such as a carrier wave or other transport mechanism, and include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media.

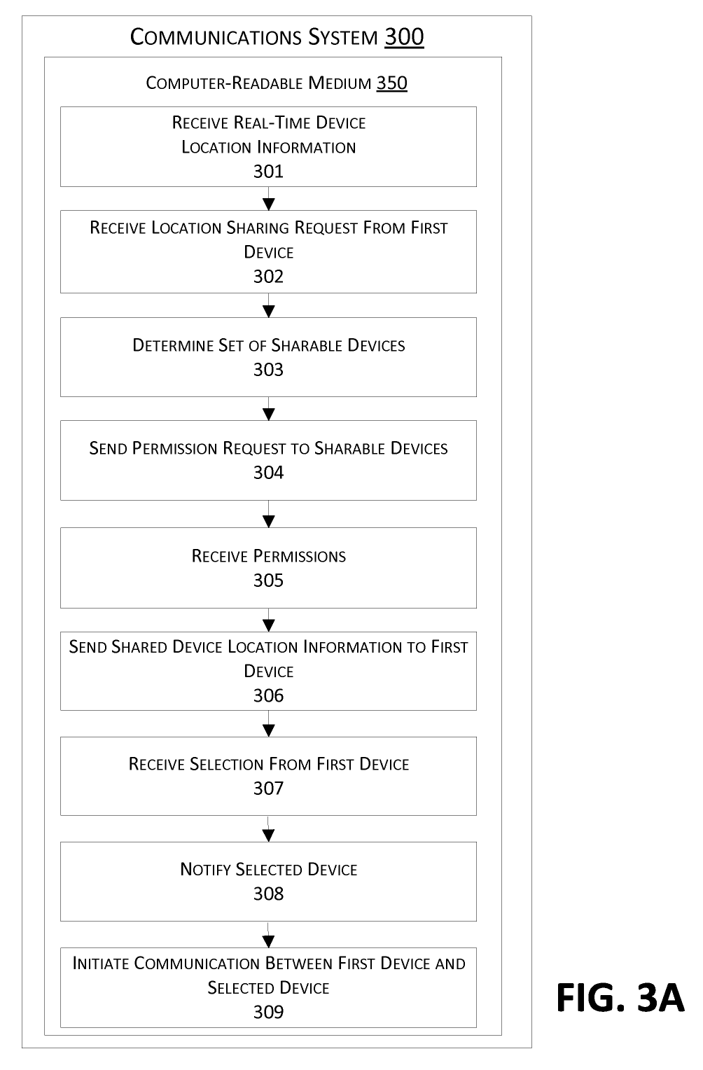

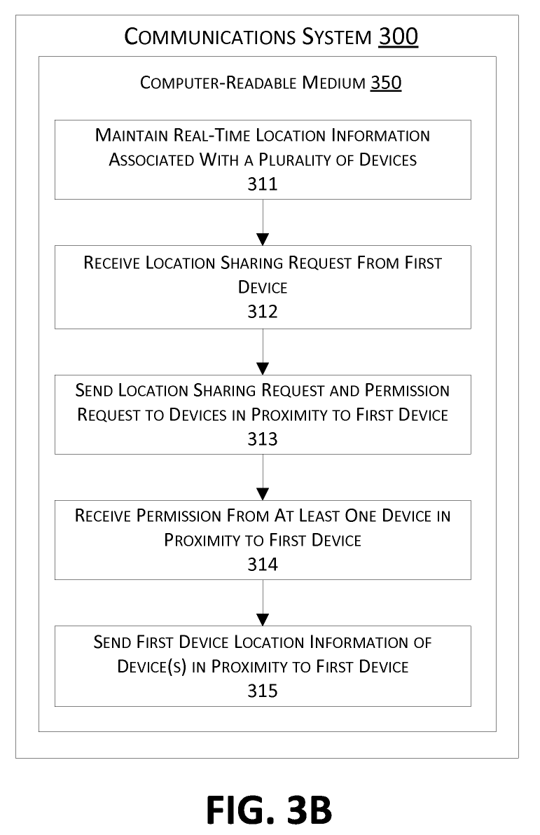

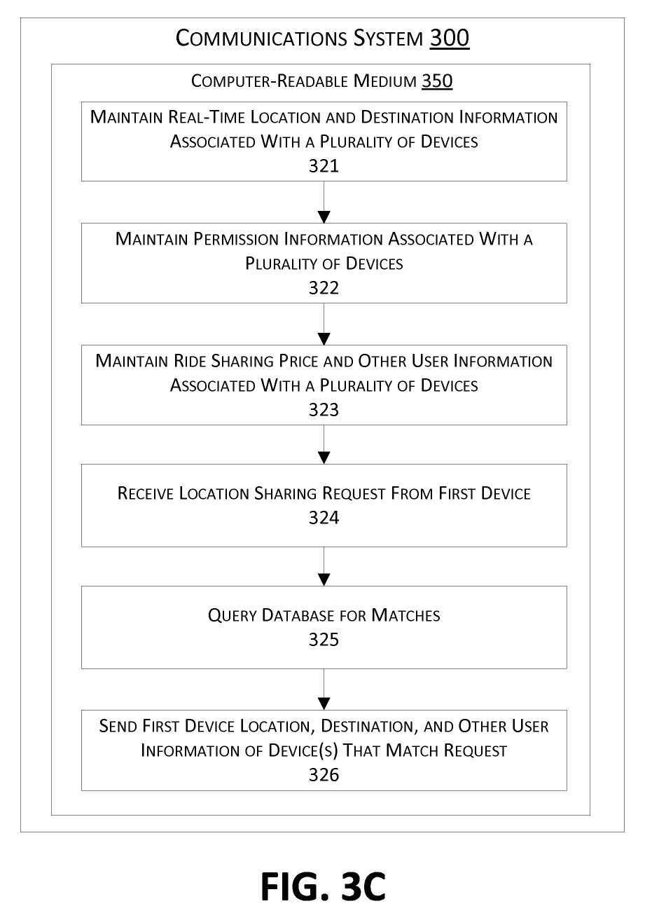

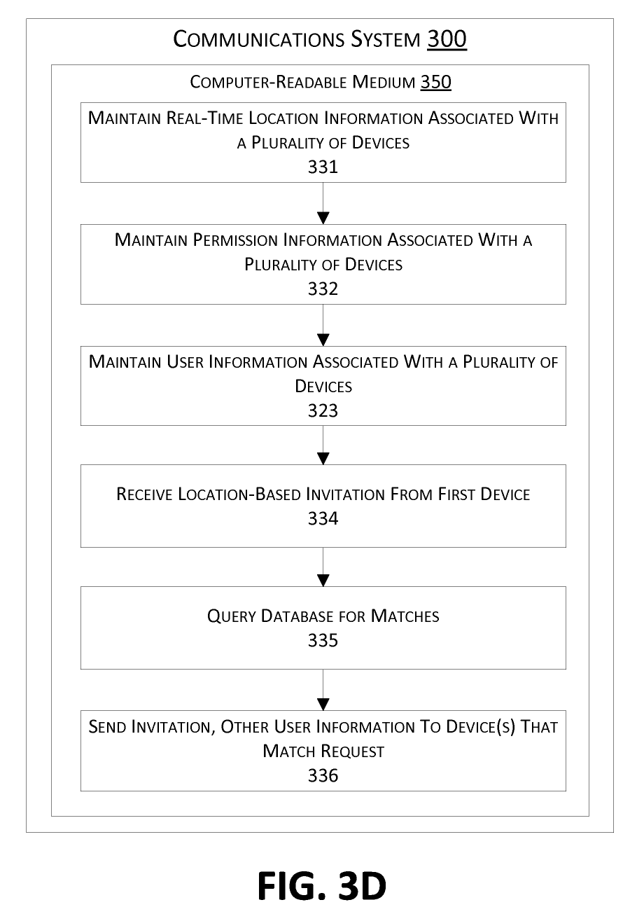

FIG. 3A is a block diagram illustrating an example communications system 300 as may implement aspects of communications system 100 in FIG. 1, arranged in accordance with the present disclosure. Communications system 300 includes a computer readable medium 350, which in turn includes operations/modules 301-309 for performing functional operations. The illustrated modules 301-309 are arranged to provide functional operations including “Receive Real-Time Device Location Information” at operation/module 301, “Receive Location Sharing Request From First Device” at operation/module 302, a “Determine Set of Sharable Devices” at operation/module 303, “Send Permission Request to Sharable Devices” at operation/module 304, “Receive Permissions” at operation/module 305, “Send Shared Device Location Information to First Device” at operation/module 306, “Receive Selection From First Device” at operation/module 307, “Notify Selected Device” at operation/module 308, and “Initiate Communication Between First Device and Selected Device” at operation/module 309.

In FIG. 3A, operations/modules 301-309 are illustrated as being performed sequentially, with operation/module 301 first and operation/module 309 last. It will be appreciated however that these operations/modules may be re-ordered as convenient to suit particular embodiments, and that these operations/modules or portions thereof may be performed concurrently in some embodiments.

FIG. 3A discloses functional modules that may be implemented by hardware and/or software in a communications system 300, as well as instructions that may be stored on a computer readable medium 350, and operations of a method as may be carried out by a communications system 300. FIG. 3A will be described herein as a method with the understanding that the disclosure also contemplates hardware and software implementations designed to carry out such a method.

In a “Receive Real-Time Device Location Information” operation/module 301, the communication system 300 may receive real-time location information of a plurality of devices. The communications system receives real-time device location information and optionally a variety of other information. This information may be received directly from devices, or from a device location information service such as 130 from FIG. 1. The received information may be placed in a memory accessible to the communications system 300, which may include for example a user information database 103 illustrated in FIG. 1. Real-time location information may comprise current locations of devices. In the case of mobile devices, such real-time location information may be periodically recalculated by the devices, or reset by device users, as the devices move around. The recalculated or reset location information may be sent to the communications system by the devices. Alternatively, devices may recalculate and/or resend location information on an as-needed basis, for example each time a device moves some predetermined distance away from a previously reported location. In the case of generally fixed-location devices such as desktop computers, device location may be initially set by a user and may not need frequent updating. Real-time location information may include any location identifying information. For example, location information may include GPS location information, latitude and longitude, nearest postal address, nearest radio communications tower, and/or nearest wireless access point information.

In a “Receive Location Sharing Request From First Device” operation/module 302, the communications system 300 may receive a location sharing request from a first device. The received location sharing request may be stored on a computer-readable medium 350. The request may comprise, for example, a data structure comprising header information identifying the first device, a user of the first device, and identifying the request as a location sharing request. The data structure may also comprise body information comprising additional data/search parameters. The amount of additional data and search parameters that may be included in the request may vary depending on the embodiment. In a first embodiment, the location sharing request may contain much of the information needed by the communications system 300 to match the location sharing request with other devices appropriate to the request. In a second embodiment, the user information database 103 and/or device location information service 130 may already contain much of the information needed to match the location sharing request with other devices appropriate to the request. It will be appreciated that data in the user information database 103 may be supplied on a per-request basis and vice-versa.

Examples of additional data and search parameters that may be included with, or retrieved for, a location sharing request are: a proximity parameter identifying how nearby other devices must be in order to satisfy the request; a destination parameter identifying a destination of the first device, for example to implement a ride sharing service; activity parameters indicating a desired activity such as ride share, walk share, share a meal, work share, watch a movie, hike, bike, or other activity; and user information parameters, for example comprising one or more of employer information, group affiliation information, certification information, and user preference information. User preference information may comprise information such as preferred gender, smoking or non-smoking, preferred age ranges, names of preferred individuals and so forth.

In a “Determine Set of Sharable Devices” operation/module 303, the communication system 300 may determine a set of devices with location information that is shareable with a first device. This may entail performing a query over data associated with devices such as 160 in FIG. 1, for example as may be stored in user information database 103. The query may return devices with parameters that satisfy the query, and such devices may be considered to have location information that is “shareable” with the first device. The selection of devices that meet the search parameters may be based on a variety of location-related criteria, such as proximity of start location, proximity of destination, or shortest time, or a variety of user-related criteria, such as place of employment, work hours, or personal interests. For example, the query may utilize proximity information to determine the set of shareable devices, the proximity information comprising proximities of the plurality of devices to the first device. In this case, the query may establish a first parameter that specifies devices within some predetermined proximity range from the first device, such as one square mile, one city block, ten minutes drive time, or the like. The query may alternatively or in addition utilize destination information to determine the set of shareable devices, the destination information comprising destinations associated with the plurality of devices and a destination of the first device. In this case, the query may establish a second parameter that specifies devices associated with a particular destination, such as “airport,” “art museum,” “courthouse,” “XYZ company headquarters,” “JKL office building,” or the like. Utilizing both of the above parameters—proximity and destination—the communications system may match proximity and destination information of devices among a plurality of devices with proximity and destination information of the first device to implement a ride sharing service.

The query may alternatively or in addition utilize device user information comprising one or more of employer information, group affiliation information, certification information, and user preference information. In this case, the query specifies such user information, such as whether a device user is an employee of XYZ company or member of ABC group, whether a device user has passed a criminal background check or has a driver's license or other certification, whether a device user is on a user preference list associated with the first device, or other information which may be selected to implement the particular needs and desires of the users of a location sharing service.

In a “Send Permission Request to Sharable Devices” operation/module 304, the communication system 300 may send a permission request to the set of devices determined in operation 303 to be shareable. The permission request may comprise a request to disclose location information to the first device. The permission request may take a number of forms. It could be a call from an automated system, for example orally asking the recipient for approval to disclose the recipient's location. It could also be a text message or instant message requesting the recipient to perform some act, such as pushing a particular button on a mobile device, to indicate permission or no permission to disclose the recipient's location. The permission request may include user information associated with a user of the first device, the user information comprising one or more of a user name, user gender, employer information, group affiliation information, certification information, and user preference information, or any additional information as may be useful in evaluating by the recipient whether to disclose the recipient's location to the requesting party.

In a “Receive Permissions” operation/module 305, permissions or permission denials may be received from the devices that were sent a permission request in operation 304. A permission may take a variety of forms, as with the permission request. In the case where permission is requested via telephone call from an automated system, the permission may take the form of a recipient saying a word or phrase such as “yes.” A permission denial may take the form of a recipient saying a word or phrase such as “no.” This utterance may be processed by a speech recognition system similar to the many speech recognition systems understood and in use today, or as may be further developed in the future. In the case where permission is requested via text message, the permission may take the form of a reply text message with a word or phrase such as “yes” or “no” in the body of the message. The reply message is then parsed to determine if it is a permission or denial. A time period for response to a permission request may also be utilized. Any devices failing to respond within the time period may for example be considered to have denied permission to disclose location of the device.

In the alternative, a user might wish to always disclose his or her location information without being asked for permission, or might wish to never disclose his or her information to certain users. For example, someone who regularly seeks shared rides may wish all prospective riders to know his or her location without the additional operation of granting permission each time a prospective match is found. As another example, a nonsmoking user might want to specify that he or she not be offered rides with smokers. In such cases, the communications system 300 would have a mechanism for storing user preferences on a computer-readable medium 350, allowing users to specify when their information may always be shared or never be shared. Users also might opt to manually select users from a list of potential matches, or to have the system automatically select a match for them.

In a “Send Shared Device Location Information to First Device” operation/module 306, the communication system 300 may send shared device location information to the first device, the shared device location information may include device locations of devices that grant permission in response to the permission request. This information may, in some embodiments, simply provide an address or other textual description of a shared device location. In another embodiment, the device location information may be designed to interoperate with a map program running on the first device, so that the map program may display a map interface on a device display, with visual indicators of shared device locations on the map interface.

Device location information may be accompanied by other information regarding the devices and users of the devices. For example, in one embodiment, a ride sharing price may accompany the location information. This contemplates commercial embodiments in which taxicabs and other transportation vendors may sell their services via the systems provided herein. In another embodiment, user information may accompany the location information. The user information may be associated with devices that grant permission in response to the permission request to the first device. In this way, the user of the first device may be informed of certain desired information about the users of the devices that shared location information, for example employer information and the like as disclosed above, and/or contact information such as a telephone number or email so that the user of the first device may contact the users of the devices that shared their location.

In a “Receive Selection From First Device” operation/module 307, the communication system 300 may receive a device selection from the first device from among the devices that grant permission in response to the permission request. It should be noted that this operation, and operations 308 and 309, may be omitted in some embodiments, for example by simply allowing the user of the first device to contact any devices that granted permission in response to the permission request, for example using contact information for such devices as may be provided. However, it may be useful to facilitate the selection and contact of other device users, as provided herein. Receiving a selection as in operation 307 may comprise receiving a text message, telephone call, or other data indicating a selected device. Devices shared with the first device in operation 306 may for example each be assigned a number, and a text message may indicate a selected device number. In another embodiment, a map program running on a device may be configured to automatically send device selection data to the communications system 300 upon user selection of a particular device using a mouse, trackball, touch screen or other selection device. This data may be received and parsed by the communications system, and a determination based thereon as to which device is selected.

In a “Notify Selected Device” operation/module 308, the communication system 300 may notify a device that grants permission in response to the permission request whether such device was selected by the first device. This notification may for example take one of the forms discussed above with reference to the permission request of operation 304. The notification may include contact information or other data or control information to initiate communication between the first device and the selected device as in operation 309.

In a “Initiate Communication Between First Device and Selected Device” operation/module 309, the communication system 300 may initiate communication between the first device and a device selected by the first device from among the devices that grant permission in response to the permission request. This initiation may comprise, for example, providing selectable data to the first device, the selected device, or both, which, upon selection, causes such device to communicate with the other device. For example, the map program discussed above, or a separately implemented software tool running on a device may be configured to receive contact information for another device, display a user interface control asking if the user wants to contact the other device, and, when the control is selected, initiate a communication with the other device.

In some embodiments, certain operations described above may be altered or omitted to implement a location-based invitation service that uses real-time location information, but which need not disclose real-time information among users of the system. In these embodiments, an invitation to meet at a specified location and time may be forwarded to devices by a communication system 300, based in part on real-time location information associated with such devices. A first device may send a real-time location based invitation to the communication system 300. The communication system 300 may determine a set of shareable devices, based on real time-location of other devices and other data as discussed above. The communication system 300 may forward the invitation to the set of shareable devices. Responses may optionally be relayed back to the first device and/or to any other devices accepting the invitation. In these embodiments, an invitation may for example apply to a volleyball game at a nearby beach, basketball at a play yard, darts at a pub, a discussion group on a suggested topic at a coffee shop, bird watching at a park etc. Devices accepting the invitation need not be required to reveal their exact location. Devices accepting the invitation may optionally agree to a mutual meeting place and time to meet, or propose alternatives.

FIG. 3B is a block diagram illustrating another example communications system 300 as may implement aspects of communications system 100 in FIG. 1, arranged in accordance with the present disclosure. Like FIG. 3A, FIG. 3B furthermore discloses functional modules as may be implemented by hardware and software in a communications system 300, instructions that may be stored on a computer readable medium 350, and operations of a method as may be carried out by a communications system 300. FIG. 3B will be described herein as a method with the understanding that the disclosure also contemplates hardware and software implementations designed to carry out such a method.

FIG. 3B illustrates another example method that may be performed by a communications system as illustrated in FIG. 1. Communications system 300 includes a computer readable medium 350, which in turn includes operations/modules 311-315. Operations/modules 311-315 include a “Maintain Real-Time Location Information Associated With a Plurality of Devices” operation/module 311, a “Receive Location Sharing Request From First Device” operation/module 312, a “Send Location Sharing Request and Permission Request to Devices in Proximity to First Device” operation/module 313, a “Receive Permission From At Least One Device in Proximity to First Device” operation/module 314, and a “Send First Device Location Information of Device(s) in Proximity to First Device” operation/module 315.

In a “Maintain Real-Time Location Information Associated With a Plurality of Devices” operation/module 311, which is similar to operation 301 in FIG. 3A, the communications system may receive and maintain real-time device location information and optionally a variety of other information. This information may be received directly from devices, or from a device location information service such as 130 from FIG. 1. The received information may be placed in a memory accessible to the communications system 300, which may include for example a user information database 103 illustrated in FIG. 1. Real-time location information may comprise current locations of devices, may be periodically recalculated by the devices or reset by device users, and may include any location identifying information such as GPS location information, latitude and longitude, nearest postal address, nearest radio communications tower, and/or nearest wireless access point information.

In a “Receive Location Sharing Request From First Device” operation/module 312, the communications system 300 may receive a location sharing request from a first device, similarly to operation 302 in FIG. 3A. The received location sharing request may be stored on a computer-readable medium 350. The request may comprise, for example, header information identifying the first device, a user of the first device, and identifying the request as a location sharing request, and body information comprising additional data/search parameters. In various embodiments, the location sharing request may contain much of the information needed by the communications system 300 to match the location sharing request with other devices appropriate to the request, or the user information database 103 and/or device location information service 130 may already contain much of the information needed to match the location sharing request with other devices appropriate to the request.

In a “Send Location Sharing Request and Permission Request to Devices in Proximity to First Device” operation/module 313, the communication system 300 may send a location sharing request and a permission request to the set of devices determined in operation 311 to be in proximity to a first device. As in operation/module 304 above, the request may take a number of forms—for example, a call from an automated system, a text message or instant message, or another method of notification. The permission request may include user information associated with a user of the first device, the user information comprising one or more of a user name, user gender, employer information, group affiliation information, certification information, and user preference information, or any additional information as may be useful in evaluating by the recipient whether to disclose the recipient's location to the requesting party.

In a “Receive Permission From At Least One Device in Proximity to First Device” operation/module 314, permissions or permission denials may be received from the devices that were sent a permission request in operation 313. As in operation 305 above, permission may take a variety of forms, such as the recipient saying a word or phrase in response to a telephone call from an automated system, the word or phrase then being processed by a speech recognition system, or the recipient replying to a text message with a permission or denial. A time period for response to a permission request may also be utilized, for example, with any devices failing to respond within the time period being considered to have denied permission to share location of the device.

In a “Send First Device Location Information of Device(s) in Proximity to First Device” operation/module 315, the communication system 300 may send shared device location information to the first device, the shared device location information may include device locations of devices determined to be in proximity to the first device that have granted permission in response to the permission request. This information may, in one embodiment, simply provide an address or other textual description of a shared device location. In another embodiment, the device location information may be designed to interoperate with a map program running on the first device, so that the map program may display a map interface on a device display, with visual indicators of shared device locations on the map interface.

As described in operation 306 above, device location information may be accompanied by other information regarding the devices and users of the devices, such as a ride sharing price, or a variety of types of user information. In this way, the user of the first device may be informed of certain desired information about the users of the devices that shared their location information, for example employer information and the like as disclosed above, and/or contact information such as a telephone number or email so that the user of the first device may contact the users of the devices that shared their location.

FIG. 3C is a block diagram illustrating another example communications system 300 as may implement aspects of communications system 100 in FIG. 1 arranged in accordance with the present disclosure. Like FIG. 3A, FIG. 3C furthermore discloses functional modules as may be implemented by hardware and software in a communications system 300, instructions that may be stored on a computer readable medium 350, and operations of a method as may be carried out by a communications system 300. FIG. 3C will be described herein as a method with the understanding that the disclosure also contemplates hardware and software implementations designed to carry out such a method.

FIG. 3C illustrates another example method that may be performed by a communications system as illustrated in FIG. 1. In this embodiment, the communications system 300 includes a computer readable medium 350, which in turn includes operations/modules 321-326. Operations/modules 321-326 may include a “Maintain Real-Time Location and Destination Information Associated With a Plurality of Devices” operation/module 321, a “Maintain Permission Information Associated With a Plurality of Devices” operation/module 322, a “Maintain Ride Sharing Price and Other User Information Associated With a Plurality of Devices” operation/module 323, a “Receive Location Sharing Request From First Device” operation/module 324, a “Query Database for Matches” operation/module 325, and a “Send First Device Location, Destination, and Other User Information of Device(s) That Match Request” operation/module 326.

In a “Maintain Real-Time Location and Destination Information Associated With a Plurality of Devices” operation/module 321, the communications system 300 may obtain real-time location and destination information for a number of devices and stores the information on a computer-readable medium 350. In a “Maintain Permission Information Associated With a Plurality of Devices” operation/module 322, the communications system 300 may also store permission information on a computer-readable medium 350. The permission information may be a stored user preference that permission always be granted to share location and any other permitted user data with other users. For example, a taxi service may wish to have sharing permission stored and automatically accessed, rather than being queried for permission each time a prospective rider is available. Similarly, in a “Maintain Ride Sharing Price and Other User Information Associated With a Plurality of Devices” operation/module 323, ride sharing price and other user information may be stored indefinitely so that the user does not have to repeatedly enter the same information. Alternatively, the user might have a stored preference to be queried only when certain conditions are met; for example, when the desired trip is longer than a specified distance.

In a “Receive Location Sharing Request From First Device” operation/module 324, the communications system 300 may receive a request with search parameters from a first device. In a “Query Database for Matches” operation/module 325, the communications system 300 may perform a search of the stored data from operations/modules 321-323 to determine which devices meet the parameters of the search.

In a “Send First Device Location, Destination, and Other User Information of Device(s) That Match Request” operation/module 326, the communications system 300 may transmit all data that matches the search parameters to the first device, indicating which devices are potential matches for its query.

FIG. 3D is a block diagram illustrating another example communications system 300 as may implement aspects of communications system 100 in FIG. 1 arranged in accordance with the present disclosure. Like FIG. 3A, FIG. 3D furthermore discloses functional modules as may be implemented by hardware and software in a communications system 300, instructions that may be stored on a computer readable medium 350, and operations of a method as may be carried out by a communications system 300. FIG. 3D will be described herein as a method with the understanding that the disclosure also contemplates hardware and software implementations designed to carry out such a method.

FIG. 3D illustrates another example method that may be performed by a communications system as illustrated in FIG. 1. In this embodiment, the communications system 300 includes a computer readable medium 350, which in turn includes operations/modules 331-336. Operations/modules 331-336 may include a “Maintain Real-Time Location Information Associated With a Plurality of Devices” operation/module 331, a “Maintain Permission Information Associated With a Plurality of Devices” operation/module 332, a “Maintain User Information Associated With a Plurality of Devices” operation/module 333, a “Receive Location-Based Invitation From First Device” operation/module 334, a “Query Database for Matches” operation/module 335, and a “Send Invitation, Other User Information To Device(s) That Match Request” operation/module 336.

In a “Maintain Real-Time Location Information Associated With a Plurality of Devices” operation/module 331, the communications system 300 may obtain real-time location and destination information for a number of devices and stores the information on a computer-readable medium 350. In a “Maintain Permission Information Associated With a Plurality of Devices” operation/module 332, the communications system 300 may also store permission information on a computer-readable medium 350. The permission information may be a stored user preference that permission always be granted to share location and any other permitted user data with other users.

In a “Maintain User Information Associated With a Plurality of Devices” operation/module 333, user interest information may be stored. For example, users may be interested in participating in pick-up basketball games, or any other group activity, near their present location. The users may therefore desire to receive invitations for such activities occurring nearby. This user interest information may be stored, along with related information such as how far a user is willing to travel, or stipulations regarding times, places, or other criteria pertaining to when, where, with whom, and what the user is interested in participating in.

In a “Receive Location-Based Invitation From First Device” operation/module 334, the communications system 300 may receive a location-based invitation from a first device. In some embodiments, the location-based invitation may include location, time, and activity information. Additional data such as maximum or minimum number of participants, required participants, preferred participants, organizer comments, items to bring to the activity, an indication of whether the organizer will accept/read invitation responses, an indication of whether participants may propose new times and places, and so forth may also be included depending on the embodiment.

In a “Query Database for Matches” operation/module 335, the communications system 300 may perform a search of the stored data from operations/modules 331-333 to determine which devices meet the parameters of the search. For example, the communications system 300 may determine which other devices are both associated with users who have expressed interest in the activity specified in the invitation, and are also associated with a real-time location that is within range of the location designated for the activity in the invitation. The range may be a default range, such as 5 kilometers, that is used for all invitations of a particular type, or it may be based on a range provided in the invitation, or it may be sent to devices based on ranges allowable for particular activities as designated in user information associated with individual devices.

In a “Send Invitation, Other User Information To Device(s) That Match Request” operation/module 336, the communications system 300 may send the invitation to devices returned by the query of step 335. In some embodiments, other user information may be sent along with the invitation, such as user information regarding the activity organizer, and user information regarding any others who accept the invitation. This information may be updated from time to time as additional participants accept the invitation.

In some embodiments, operations 335 and 336 may be repeated multiple times. For example, if the invitation is sent in the morning for an activity to occur in the evening, additional devices may come in range of the activity as the day goes on. These devices can be identified by repeating operation 335, and an invitation can be sent to such new devices by repeating operation 336. In the case of a repeat of 336, the invitation may be restricted to those devices that have not previously received an invitation.

In some embodiments, the communications system 300 may furthermore maintain data regarding an activity once an invitation is sent. A link to real-time activity data may be sent to the first device as well as to any devices to which the invitation is sent. Alternatively, occasional activity data updates may be sent to devices in the form of an email, text message, or the like. Activity data may include information such as how many have accepted, names and contact information of the participants, time and location updates, activity discussion information posted by participants, and so on.

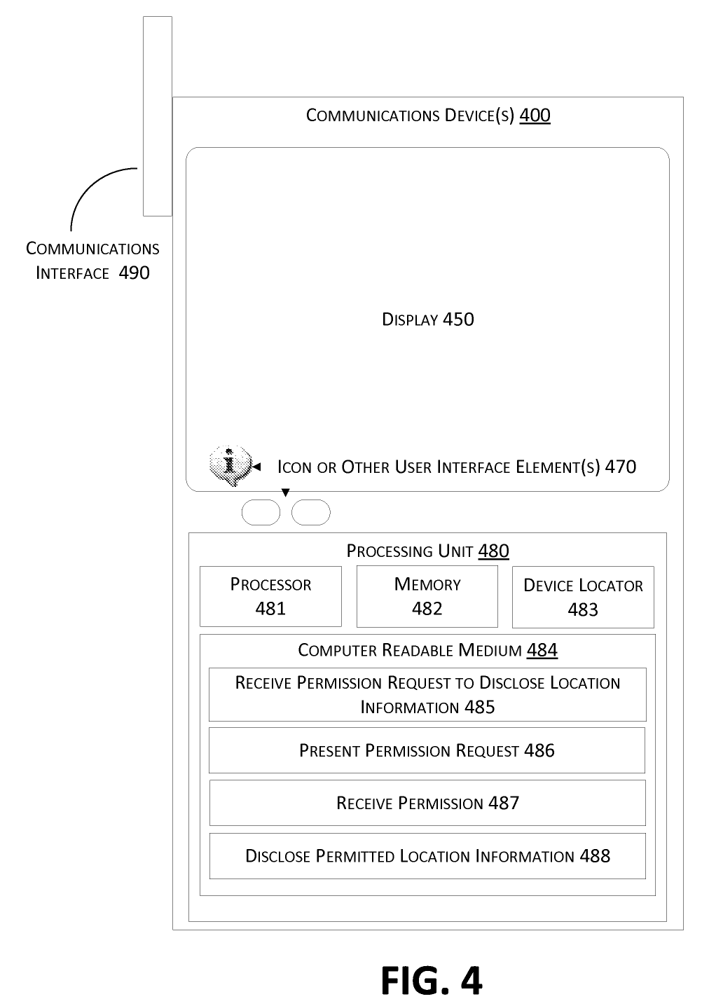

FIG. 4 is a block diagram illustrating one example of a communications device 400 configured to facilitate real-time location information sharing. Communications device 400 may include a display 450, a communications interface 490, an icon or other user interface element(s) 470, and a processing unit 480. The processing unit 480 may in turn include a processor 481, memory 482, a device locator 483, and a computer readable medium 484. The computer readable medium 484 may comprise operations/modules 485-488, which include a “Receive Permission Request to Disclose Location Information” operation/module 485, a “Present Permission Request” operation/module 486, a “Receive Permission” operation/module 487, and a “Disclose Permitted Location Information” operation/module 488.

In FIG. 4, operations/modules 485-488 are illustrated as being performed sequentially, with operation/module 485 first and operation/module 488 last. It will be appreciated however that these operations/modules may be re-ordered as convenient to suit particular embodiments, and that these operations/modules or portions thereof may be performed concurrently in some embodiments.

FIG. 4 discloses functional modules that may be implemented by hardware and/or software in a device processing unit 480, as well as instructions that may be stored on a computer readable medium 484, and operations of a method as may be carried out by a device processing unit 480. FIG. 4 will be described herein as a method with the understanding that the disclosure also contemplates hardware and software implementations designed to carry out such a method.

In some embodiments, device 400 may be a cellular telephone or other mobile device. In another embodiment, device 400 may be a personal computer or laptop. This device 400 may contain many of the same elements as the computing device shown in FIG. 2. The display 450 might be used to convey messages to the user via an icon or other user interface element 470 (e.g., a user interface button on the device), such as a message may be received from the communications system illustrated in FIG. 1 via the communications interface 490, requesting permission to share user location information. The display 450 also might receive input from the user, such as permission to share user location information, or manual entry of user information. This user information may be stored in the processing unit 480 and, when the user grants permission, shared with the communications system illustrated in FIG. 1 via the communications interface 490. Examples of methods by which messages might be conveyed include phone calls, e-mails, instant messages, or text messages such as Short Message Service (SMS) messages. Another example might be a user interface icon or button on the device that allows users to poll other users for availability.

The device locator 483 may comprise Global Positioning System (GPS) or radio location service technologies that enable it to communicate its location to other devices. Alternatively, the device locator may comprise user-entered data that indicates the device's current location. The device locator may be configured, for example, to automatically update its location whenever it travels, or at fixed time intervals, or when it moves beyond a certain distance from its starting location.

The processing unit 480, which executes a sequence of stored instructions, may be configured to perform one or more functions. For example, in a “Receive Permission Request to Disclose Location Information” operation/module 485, the device may receive a request from the communications system 300 via the communications interface 490 for permission to disclose its location to a remote device. In a “Present Permission Request” operation/module 486, the device may present the permission request to the device user via an icon or other user interface element 470, such as an element on the display or a button on the device.

In a “Receive Permission” operation/module 487, the device may receive permission from the user via an icon or other user interface element 470 on the display or the device to disclose the device location information to the communications system 300. Depending on the form of the permission request, the user may grant permission verbally, via an e-mail or other message, or by pushing a button or otherwise interacting with the device. The user may refuse permission by indicating via the same methods that the device location may not be shared, or by not responding within a specified timeframe. In the alternative, a user might wish to always disclose his or her location information without being asked for permission, or might wish to never disclose his or her information to certain users. In such cases, user preferences could be stored on the communications system 300 and permission would be automatically granted or refused.

In a “Disclose Permitted Location Information” operation/module 488, if the permission request was not granted directly to the communications system, for example through a phone message, e-mail, or other form of messaging, the communications device may initiate contact with the communications system 300 to authorize it to disclose location information to a remote device.

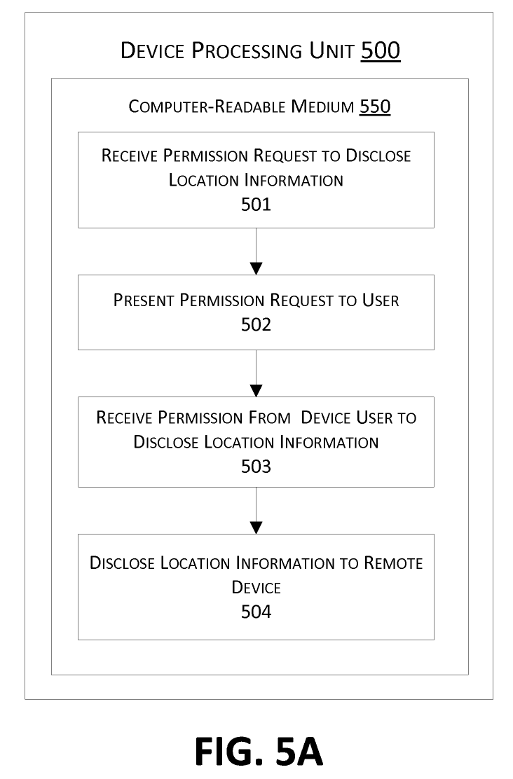

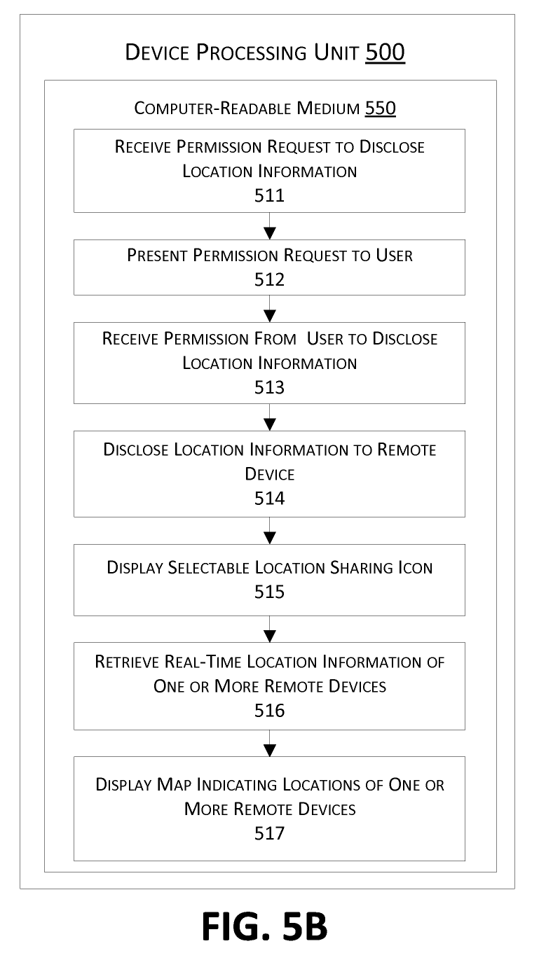

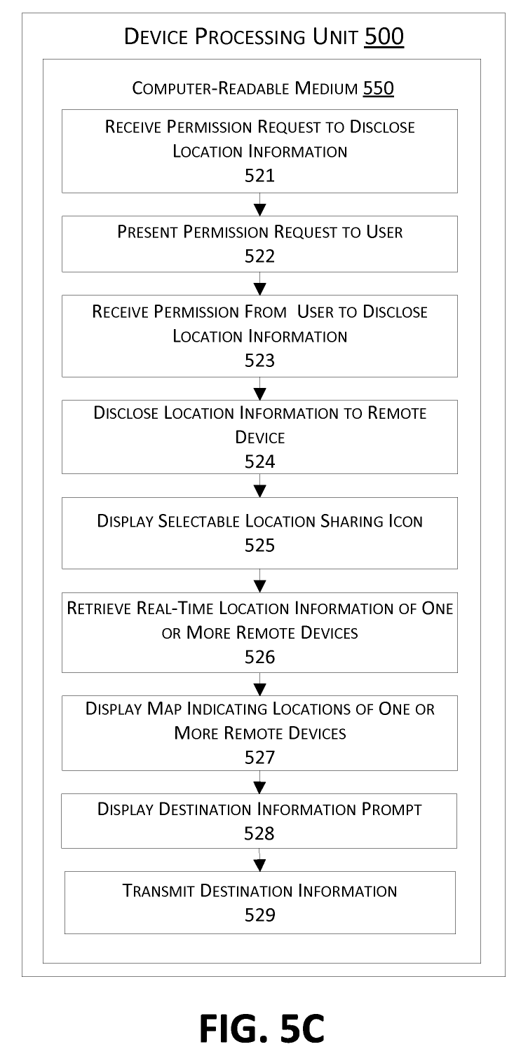

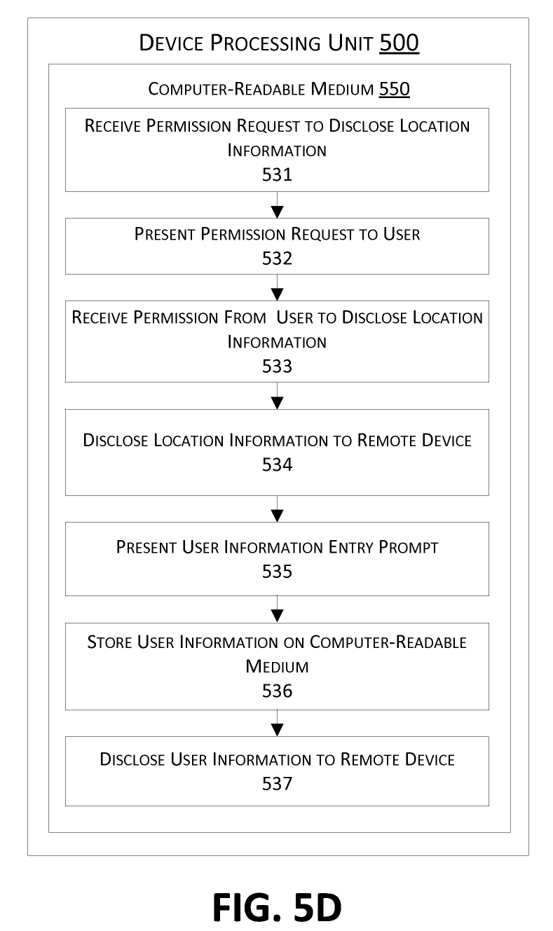

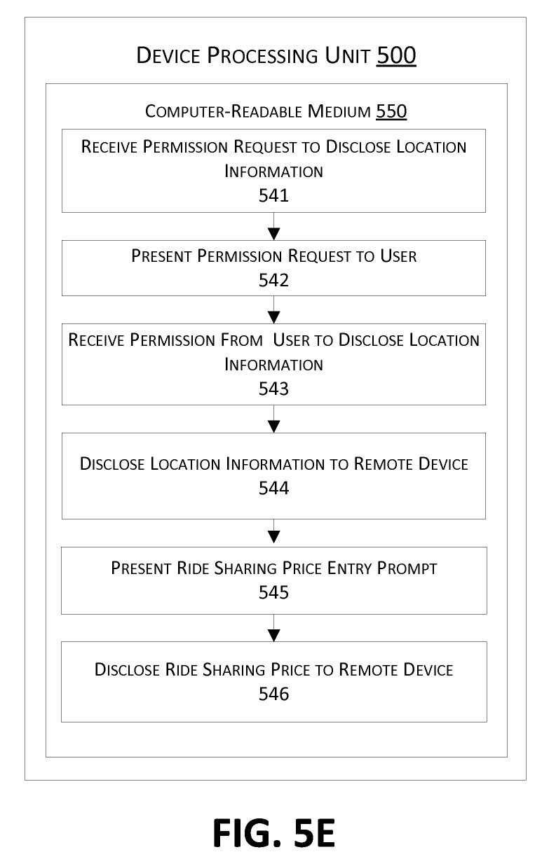

FIGS. 5A-5E are block diagrams illustrating example device processing units 500 as may implement aspects of communications device 400 in FIG. 4, all arranged in accordance with the present disclosure. FIGS. 5A-5E disclose functional modules that may be implemented by hardware and/or software in a communications device 400, as well as instructions that may be stored on a computer readable medium 450, and operations of a method as may be carried out by a communications device 400. FIGS. 5A-5E will be described herein as methods with the understanding that the disclosure also contemplates hardware and software implementations designed to carry out such methods.

FIG. 5A illustrates an example method that may be performed in connection with a communications device as illustrated in FIG. 4 arranged in accordance with the present disclosure. In the method illustrated in FIG. 5A, the device processing unit 500 includes a computer readable medium 550, which in turn includes operations/modules 501-504. Operations/modules 501-504 include a “Receive Permission Request to Disclose Location Information” operation/module 501, a “Present Permission Request to User” operation/module 502, a “Receive Permission From Device User to Disclose Location Information” operation/module 503, and a “Disclose Location Information to Remote Device” operation/module 504

In FIG. 5A, operations/modules 501-504 are illustrated as being performed sequentially, with operation/module 501 first and operation/module 504 last. It will be appreciated however that these operations/modules may be re-ordered as convenient to suit particular embodiments, and that these operations/modules or portions thereof may be performed concurrently in some embodiments.

In a “Receive Permission Request to Disclose Location Information” operation/module 501, a communications device processing unit 500 such as the processing unit 480 depicted in FIG. 4 may receive a request from the communications system 300 depicted in FIG. 3 for permission to disclose its location information to other users. In a “Present Permission Request to User” operation 502, in one embodiment, the processing unit may display an icon or other user interface element on the display, requesting permission from the user to disclose location information. In another embodiment, the processing unit may prompt the user to grant or refuse permission through a button or other user interface element on the device.

In a “Receive Permission From Device User to Disclose Location Information” operation/module 503, the device processing unit may receive a prompt from the user through an icon or other user interface element that the user grants permission to disclose location information to one or more remote users. Depending on the form of the permission, the device may communicate with the communications system 300 via the communications interface 490 to parse the user response and determine whether permission has been granted.

In a “Disclose Location Information to Remote Device” operation/module 504, the communications device may initiate communication with the communications system 300 to authorize it to disclose location information to a remote device.

FIG. 5B illustrates an example method that may be performed in connection with a communications device as illustrated in FIG. 4 arranged in accordance with the present disclosure. In the method illustrated in FIG. 5B, the device processing unit 500 as described in FIG. 5A includes operations/modules 511-514, which duplicate operations/modules 501-504 in FIG. 5A, as well as operations/modules 515-517, which comprise a “Display Selectable Location Sharing Icon” operation/module 515, a “Retrieve Real-Time Location Information of One or More Remote Devices” operation/module 516, and a “Display Map Indicating Locations of One or More Remote Devices” operation/module 517.

In FIG. 5B, operations/modules 511-517 are illustrated as being performed sequentially, with operation/module 511 first and operation/module 517 last. It will be appreciated however that these operations/modules may be re-ordered as convenient to suit particular embodiments, and that these operations/modules or portions thereof may be performed concurrently in some embodiments.

In a “Display Selectable Location Sharing Icon” operation/module 515, the device may display an icon or other user interface element for the user to select. Upon selection of this icon, in a “Retrieve Real-Time Location Information of One or More Remote Devices” operation/module 516, the device may initiate communication via the communications interface 490 with the communications system 300 to obtain the location of one or more remote devices to which the user has been prospectively matched.

In a “Display Map Indicating Locations of One or More Remote Devices” operation/module 517, the device may receive location data from the communications system 300 that interacts with a map program running on the device, so that the map program may display a map interface on the device display, visually indicating shared device locations on the map interface.

FIG. 5C illustrates an example method that may be performed in connection with a communications device as illustrated in FIG. 4 arranged in accordance with the present disclosure. In the method illustrated in FIG. 5C, the device processing unit 500 as described in FIG. 5B includes operations/modules 521-527, which duplicate operations/modules 511-517 in FIG. 5B, as well as operations/modules 528-529, which comprise a “Display Destination Information Prompt” operation/module 528 and a “Transmit Destination Information” operation/module 529.

In FIG. 5C, operations/modules 521-529 are illustrated as being performed sequentially, with operation/module 521 first and operation/module 529 last. It will be appreciated however that these operations/modules may be re-ordered as convenient to suit particular embodiments, and that these operations/modules or portions thereof may be performed concurrently in some embodiments.

In a “Display Destination Information Prompt” operation/module 528, the device may display via an icon or other user interface element a prompt for the user to enter a desired destination to be matched with other users. The entered information is stored on the computer-readable medium 550. In a “Transmit Destination Information” operation/module 529, the device may transmit the stored information to the communications system 300 via the communications interface 490. The system then determines whether the destination matches the desired destination of other users so that a match may be suggested.

FIG. 5D illustrates an example method that may be performed in connection with a communications device as illustrated in FIG. 4 arranged in accordance with the present disclosure. In the method illustrated in FIG. 5D, the device processing unit 500 as described in FIG. 5A includes operations/modules 531-534, which duplicate operations/modules 501-504 in FIG. 5A, as well as operations/modules 535-537, which comprise a “Present User Information Entry Prompt” operation/module 535, a “Store User Information on Computer-Readable Medium” operation/module 536, and a “Disclose User Information to Remote Device” operation/module 537.

In FIG. 5D, operations/modules 531-537 are illustrated as being performed sequentially, with operation/module 531 first and operation/module 537 last. It will be appreciated however that these operations/modules may be re-ordered as convenient to suit particular embodiments, and that these operations/modules or portions thereof may be performed concurrently in some embodiments.

In a “Present User Information Entry Prompt” operation/module 535, the device may display via an icon or other user interface element a prompt for the user to enter specified information. User information may comprise one or more of employer information, group affiliation information, certification information, and user preference information. User preference information may comprise information such as preferred gender, smoking or non-smoking, preferred age ranges, names of preferred individuals, and so forth. While some of this user information may be stored in the communications system 300, the user may be given the option to update or override that information with current preferences.

In a “Store User Information on Computer-Readable Medium” operation/module 536, the device may store the entered user information on the computer-readable medium 550. In a “Disclose User Information to Remote Device” operation/module 537, the device may transmit the information via the communications interface 490 to the communications system, where it may be stored temporarily or stored as a saved user preference before being transmitted to other users.

FIG. 5E illustrates an example method that may be performed in connection with a communications device as illustrated in FIG. 4 arranged in accordance with the present disclosure. In the method illustrated in FIG. 5E, the device processing unit 500 as described in FIG. 5A includes operations/modules 541-544, which duplicate operations/modules 501-504 in FIG. 5A, as well as operations/modules 545-546, which comprise a “Present Ride Sharing Price Entry Prompt” operation/module 545 and a “Disclose Ride Sharing Price to Remote Device” operation/module 546.

In FIG. 5E, operations/modules 541-546 are illustrated as being performed sequentially, with operation/module 541 first and operation/module 546 last. It will be appreciated however that these operations/modules may be re-ordered as convenient to suit particular embodiments, and that these operations/modules or portions thereof may be performed concurrently in some embodiments.

In a “Present Ride Sharing Price Entry Prompt” operation/module 545, the device may display via an icon or other user interface element a prompt for the user to enter a ride sharing price. In a “Disclose Ride Sharing Price to Remote Device” operation/module 546, the entered price may be transmitted via the communications interface 490 to the communications system 300, which transmits it to one or more remote devices that may be matched in a ride sharing system.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communications systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various embodiments have been disclosed herein, other aspects and embodiments will be apparent to those skilled in art.

1. A communications system configured to facilitate real-time location information sharing among a plurality of devices, comprising:
a module that receives real-time location information associated with the plurality of devices;
a module that identifies a set of devices from the plurality of devices with location information that is shareable with a first one of the plurality of devices;
a module that sends a permission request to the set of devices, the permission request comprising a request to disclose location information to the first device; and
a module that sends shared device location information to the first device, the shared device location information including device locations of devices that grant permission in response to the permission request.

2. The communications system of claim 1, wherein the module that identifies the set of devices with location information that is shareable with the first device utilizes proximity information to determine the set of devices, the proximity information comprising proximities of the plurality of devices to the first device.

3. The communications system of claim 1, wherein the module that identifies a set of devices with location information that is shareable with the first device utilizes destination information to determine the set of devices, the destination information comprising destinations associated with the plurality of devices and a destination of the first device.

4. The communications system of claim 1, wherein the module that identifies a set of devices with location information that is shareable with the first device matches proximity and destination information of devices among the plurality of devices with proximity and destination information of the first device to implement a ride sharing service.

5. The communications system of claim 4, furthermore comprising a module that sends one or more ride sharing prices to the first device, wherein the ride sharing prices are associated with one or more of the devices that grant permission in response to the permission request.

6. The communications system of claim 1, wherein the module that identifies the set of devices with location information that is shareable with the first device compares device user information associated with the first device to device user information associated with the set of devices, the device user information comprising one or more of employer information, group affiliation information, certification information, and user preference information.

7. The communications system of claim 1, wherein the permission request includes user information associated with a user of the first device, the user information comprising one or more of a user name, user gender, employer information, group affiliation information, certification information, and user preference information, the user information aiding users of the set of devices in determining whether to grant the permission request.

8. The communications system of claim 1, furthermore comprising a module that sends user information associated with devices that grant permission in response to the permission request to the first device.

9. The communications system of claim 1, further comprising a module that receives a device selection from the first device from among the devices that grant permission in response to the permission request.

10. The communications system of claim 1, further comprising a module that notifies a device that grants permission in response to the permission request whether such device was selected by the first device.

11. The communications system of claim 1, further comprising a module that initiates communication between the first device and a device selected by the first device from among the devices that grant permission in response to the permission request.

12. An apparatus configured to facilitate real-time location information sharing between a user and a remote device, the apparatus comprising:
a display;
a communication interface; and
a processing unit configured to receive location information via the communications interface and to interact with the user via the display, the processing unit further configured to:
receive via the communication interface a permission request to disclose location information to the remote device; and
present the permission request via a user interface on the display;
receive a response to the permission request indicating a grant of permission via the user interface; and
disclose device location information to the remote device via the communications interface in response to the grant of permission.

13. The apparatus of claim 12, wherein the processing unit is further configured to:
present a selectable location sharing icon on the display;
in response to user selection of the selectable location sharing icon, retrieve real-time device location information of one or more remote devices via the communications interface; and
present a map on the display, the map comprising indications of locations of the one or more remote devices.

14. The apparatus of claim 13, wherein the processing unit is further configured to:
present a destination information prompt on the display, the destination information prompt requesting the device user to enter destination information; and
in response to user entry of the destination information, send the destination information via the communications interface.

15. The apparatus of claim 12, wherein the processing unit is further configured to:
present a user information entry prompt on the display;
store entered user information on a computer readable medium; and
disclose the user information to the remote device via the communications interface.

16. The apparatus of claim 12, wherein the processing unit is further configured to:
present a user information entry prompt on the display;
store entered user information on a computer readable medium; and
disclose the user information to the remote device via the communications interface.

17. The apparatus of claim 12, wherein the processing unit is further configured to:
present a ride sharing price entry prompt on the display; and
disclose an entered ride sharing price to the remote device via the communications interface.

18. A method for facilitating location information sharing among a plurality of devices, comprising:
maintaining real-time location information associated with the plurality of devices;
receiving a location-based invitation from a first one of the plurality of devices;
determining a set of devices of the plurality of devices that are both within a determined range of an activity location designated in the location-based invitation, and are associated with user profile data indicating an interest in an activity designated in the location-based invitation; and
sending the location-based invitation to the set of devices.

19. The method of claim 18, further comprising sending a link to real-time activity data along with the location-based invitation.

20. The method of claim 18, further comprising repeating the determining a set of devices at a later time, and sending the location-based invitation to any newly determined devices.
